(19) United States
(12) Patent Application Publication
(10) Pub. No.: US 2007/0251389 A1
(43) Pub. Date: Nov. 1, 2007

(54) COMPOSITE INORGANIC MEMBRANE FOR SEPARATION IN FLUID SYSTEMS

(76) Inventors: Dina Katsir, Beer Sheva (IL); Zvi Finkelstein, Asseret (IL); Daniel Feinman, Moshav Arugot (IL)

Correspondence Address: STITES & HARBISON PLLC, 1199 NORTH FAIRFAX STREET, SUITE 900, ALEXANDRIA, VA, 22314, US

(21) Appl. No.: 11/739,910

(22) Filed: Apr. 25, 2007

(30) Foreign Application Priority Data
Apr. 26, 2006 (IL) 175270

(51) Int. Cl. B01D 53/22

(52) U.S. Cl. 96/11

(57) ABSTRACT

A composite membrane for separating components of fluid mixtures including either a porous, essentially continuous, vacuum-deposited ceramic layer, supported by a porous substrate, the ceramic layer comprising at least one oxide selected from aluminum, titanium, tantalum, niobium, zirconium, silicon, thorium, cadmium and tungsten oxides, wherein the average width of the substrate pores is greater than that of the ceramic layer pores, subject to stated conditions; or a multi-layer system of at least two such ceramic layers, disposed on at least one side of, and supported by, a porous substrate, the ceramic layers comprising at least one of the above-specified oxides, wherein between successive ceramic layers, there is disposed a vacuum-deposited metallic layer wherein the porosity and (or) average pore width of the metallic layer is less than those of the ceramic layer. The invention further relates to the application of similar membranes to TLC and column chromatography.

### FIELD OF THE INVENTION

The present invention relates to a composite membrane adapted for separation of components of fluid mixtures.

### BACKGROUND OF THE INVENTION

Inorganic membranes are widely used in separation and filtration applications. Inorganic membranes are more versatile than organic polymeric membranes, e.g. they can operate at elevated temperatures, metal membranes being stable at temperatures ranging from 500° C. to 800° C., while many ceramic membranes are stable at over 1000° C. They are also much more resistant to chemical attack. In many harsh operational environments, organic membranes will not perform well, and may not survive at all. For these environments, only inorganic membranes offer needed solutions. Because of their versatility, inorganic membranes can prove a benefit to the pulp and paper industry, the food and beverage industry, waste water cleaning, sea water desalination, and energy production (advanced batteries and fuel cells).

A particular commercial application of inorganic membranes is the selective removal of hydrogen from gas mixtures produced in coal gasification, steam reforming, partial oxidation, auto-thermal reforming, biomass pyrolysis and direct biomass gasification, typically conducted at high temperatures (500-900° C.). Palladium and palladium-based (e.g. Pd alloy) membranes are considered to be good candidates for the high-temperature processes of hydrogen recovery from such reaction gas mixtures, typically containing CO, CO₂ and hydrocarbons (mainly CH₄). These membranes are permeable to hydrogen, while retaining other gases. This permselectivity, with respect to hydrogen, can be explained by a special mechanism of hydrogen permeation through palladium. When hydrogen contacts a palladium or palladium-based membrane, its molecules (H₂) dissociate and hydrogen atoms (H) diffuse into the membrane. In the atomic form, hydrogen can selectively pass from the reaction gas mixture through the membrane. The selectively-extracted hydrogen atoms then reform into H₂ molecules. Such behavior of palladium and palladium-based membranes with respect to hydrogen may be regarded as catalytic activity of palladium in the reaction of H₂-dissociation. Though other metals are reported to exhibit permselectivity with respect to hydrogen (e.g. Ni, Pt, V, Nb, Ta), palladium and palladium-based membranes remain the major commercially used membranes for hydrogen separation.

For commercial use, the membrane must ensure, besides high permselectivity with respect to hydrogen, high flux of hydrogen. It is known in the art that the flux of a permselective component is inversely proportional to the membrane thickness. This requires very thin membranes, and a need to use a support for such thin membranes. Thin Pd-based membranes are typically supported by porous metallic or ceramic substrates. The porous substrate primarily provides mechanical integrity, though it acts also as a low selectivity membrane. In the art, the terms “composite membrane” or “membrane ensemble” are usually used for designating the system comprising a membrane and a support (substrate).

If a metal or metal alloy is used as a substrate for the membrane, the following problems can arise: 1) different thermal expansion of the membrane material and the substrate material; 2) alpha and beta hydride phase transition; and 3) intermetallic diffusion between the membrane and the substrate materials. The first phenomenon results in destroying the composite membrane during the separation cycles, while the second decreases the permeability of the membrane to hydrogen. All the foregoing phenomena influence the effective life of the composite membrane.

As mentioned above, the typical membrane material is palladium. However, in industrial applications, alloys of palladium with one or more other elements, such as Ag, Cu, Ru, In, Au, Ce, Y, Ta, V, Ho are used. A disadvantage of pure palladium is that in the presence of hydrogen alpha and beta hydride phase transitions occur under 290° C. These phase transitions result in embrittlement of the membrane after repeated cycling, and therefore must be avoided. By alloying Pd with the above mentioned elements the phase transition can be suppressed. In particular, Pd-based alloys containing palladium with silver (20-30 wt. %), or palladium with Cu (40 wt. %) are known as membrane constituents. Moreover, silver alloy membranes exhibit higher permeability (up to about 70%) than the membranes utilizing pure palladium.

Intermetallic diffusion is a phenomenon where formation of an alloy on the interface between two contacted metals occurs, due to the diffusion of one metal into another. The rate of this diffusion is greatest when the metal is at or above the temperature, which is equal to one-half of its melting temperature. For example, for palladium and stainless steel these temperatures are 640° C. and 550-560° C., respectively. The lower of these temperatures determines the temperature at which a significant increase in intermetallic diffusion occurs.

Methods for the manufacture of composite membranes for hydrogen separation include either mounting a thin palladium foil on a highly permeable relatively low selectivity porous substrate, or depositing palladium on such substrate. Deposition methods for producing a palladium layer on the substrate require less palladium than the methods in which bulk palladium is applied. Besides, composite membranes produced by deposition techniques exhibit higher permeability compared to foil membranes.

The two main approaches known in the art for preventing intermetallic diffusion are: elimination of the metallic substrate and fabrication of intermediate barrier layers.

A method for preventing intermetallic diffusion by producing an intermediate barrier layer is disclosed in U.S. Pat. No. 6,152,987 (Ma et al.). This patent describes a process in which a porous stainless steel cap was oxidized with oxygen at 900° C. for 4 hours followed by surface activation in solutions of SnCl₂ and PdCl₂, rinsing with HCl and water, repeated between 2 and 5 times, and subsequent drying for 2 hours at 120° C. Following surface activation, palladium was deposited on the activated surface by an electroless plating procedure repeated 14 times. The total time of plating was 25 hours. In other variations of the process, the oxidation temperature was 600° C. and 800° C. In another embodiment, the oxidizing process was replaced by nitriding, carried out at 980° C. for 20 hours, while the stage of palladium deposition was repeated 12 times and continued 20 hours in all. The fabricated palladium layer had a thickness between 25.4 and 32.5 μm depending on duration of the deposition stage. The disclosed method involves a large volume of liquids and requires a considerable expenditure of time, as well as maintaining extremely high temperatures for a relatively long period.

U.S. Pat. No. 5,782,959 (Yang et al.) discloses a process for preparing a composite membrane in which an intermediate layer is formed by a sol-gel method in a tube-shaped alumina asymmetric support, consisting of a thin dense inner layer and a thick coarse outer layer. Afterwards, the support is modified by absorption of palladium acetate solution into the pores. Finally, palladium is vaporized under a nitrogen stream which results in the deposition of the vaporized palladium onto the pores. In the disclosed patent, no other component is doped to palladium, therefore such membrane is expected to be brittle.

A laminated composite membrane is described by Howard et al. in Journal of Membrane Science, vol. 241 (2004), pp. 207-218. The authors teach an assembly consisting of a membrane (foil composed of Pd—Cu alloy), a porous alumina sheet, acting as a barrier layer, and a rigid porous Hastelloy® support. The porous alumina sheet was simply sandwiched between the foil and the support, but not bonded to either structure. Although the authors report that in the test cycle after 72 hours at temperature 1038° K or above no degradation in membrane performance was registered, they also noted that after the assembly was disassembled, the barrier layer cracked. The manufacturing method of the disclosed membrane is rather complicated and the produced membrane cannot ensure high fluxes of hydrogen.

US 2003/0068260 (Wellington et al.) teaches a steam reforming reactor comprising two concentric tubes with a catalyst in an annulus therebetween. The inner tube includes a hydrogen selective membrane in the form of a thin film deposited by electroless plating. The membrane material can by any of Group VIII transition metals or alloys thereof. Optionally, the membrane film is deposited on a support, which can be oxide, carbide or nitride of any element belonging to Groups IIIA, IIIB, IVA and IVB of the Periodic Table. Alternatively, the support can be composed of porous stainless steel, Hastelloy® or Inconel®. The disclosed apparatus requires a relatively large membrane surface in order to handle industrial quantities of reforming gas, because of the low value of the ratio of membrane surface area to volume of apparatus. For example, in a reactor with a ½-inch inner tube diameter encased in a 1-inch diameter tube, the calculated value of this ratio is 3.2 cm²/cm³ for the membrane section and 1.6 cm²/cm³ for the entire reactor.

In the last few years, there have appeared publications demonstrating that microfabrication technology (originally developed for semiconductors) offers a new approach for the fabrication of thin and defect-free Pd-composite membranes. The resultant thin films increase both flux and permselectivity of the membrane. According to this method, Pd alloy films are first deposited on the dense and smooth surface of microfabricated supports. Due to the surface quality, the films cover the support completely, leading to defect-free membranes. Next, the supports are partially etched from the backside to create pathways for the gases to the Pd surface. The microfabricated supports allow the deposition of very thin films and can be made in forms that have a low mass transfer resistance. Examples of the foregoing publications are:
S. V. Karnik, et al. Journal of Microelectromechanical Systems, vol. 12 (2003), No 1, pp. 93-100.
H. D. Tong, et al. Journal of Microelectromechanical Systems, vol. 12 (2003), No 5, pp. 622-629.
H. D. Tong, et al. Journal of Microelectromechanical Systems, vol. 14 (2005), No 1, pp. 113-124.

A membrane obtained by the method of the foregoing publication of S. V. Karnik, et al. has a limited size and is unsuitable for the separation of large volumes of hydrogen. Unlike this, the method disclosed in the publications of H. D. Tong, et al. overcomes this limitation. These authors disclose a technique for the manufacture of a robust wafer scale separation module, comprising a thin (500-nm-thick) Pd—Ag alloy membrane on a supporting microsieve silicon wafer. The proposed module may be numbered up easily to create a system with high hydrogen throughput, suitable for industrial applications. However, the disclosed technique is very complicated and expensive, which can be seen from the following description. The wafer is coated with 0.2 μm of wet-thermal SiO₂ and 1 μm of low-stress silicon-rich silicon nitride (SiN) by means of low-pressure chemical-vapor deposition, producing thereby parallelogram-shaped structures of 600 by 2600 μm. Further, the produced structures are aligned and imprinted on the backside of the wafer by standard photolithography, followed by dry etching of the SiN in a CHF₃+O₂ plasma and wet etching of the oxide layer in buffered hydrofluoric acid. Afterwards, the wafer is immersed in 25% KOH solution at 75⁰ C. to etch the silicon until the SiO₂ layer is reached, thus forming an array of suspended bilayer SiN/SiO₂ membranes. Then, standard lithography and dry etching of SiN are carried out on the front-side of the wafer to pattern a microsieve with circular openings of 5 μm on the suspended SiN/SiO₂ membranes. After patterning, films of Pd—Ag alloy are deposited on the flat side of the membrane by simultaneous sputtering from two pure targets, one of Pd and one of Ag (both 99.999%) on 20 nm of sputtered titanium that acts as an adhesion layer. First the SiO₂ and then the titanium are removed by etching with a buffered HF solution through the opening of the sieves to reveal the back surface of the Pd—Ag film. Finally, the silicon wafer is bonded between two thick glass wafers by a four-electrode anodic bonding technique. Before the bonding procedure, powder blasting is used to create a flow channel of 200 μm depth and a buffer zone of 1000 μm in the glass wafers. According to the authors the cost of this assembly having an area of 182 cm² (6-inch Si wafer) is 340 dollars, one half of which is the cost of materials, and the second one is the cost of clean room operations.

U.S. Pat. No. 6,238,465 (Juda et al.) discloses a method for producing thin Pd—Cu membranes, wherein one metal is in the form of a thin foil, while another is a deposit, applied by electroless plating or vacuum sputtering. The patent does not specify a substrate on which the disclosed membrane has to be disposed. If the membrane is intended to be disposed on a metallic substrate, it is not clear how the authors solve the problem of different thermal expansion of the substrate and the membrane materials and the problem of intermetallic diffusion.

Application of inorganic membranes has recently expanded in such fields as biochemistry, molecular biology and like disciplines, where there is a demand for faster and more accurate techniques for recovery, purification and analysis of small amounts of biological substances such as DNA segments and proteins. Such methods as ion-exchange chromatography, affinity chromatography, and other chromatographic separation processes require as a mandatory step the separation and recovery of these biological materials from gels, broths, or like media, conventionally using either various types of adsorption columns such as ion exchange columns, or affinity-binding techniques and the like.

U.S. Pat. No. 5,976,527 (Siol et al.) teaches a system comprising latex particles which system is capable for immobilizing substances containing nucleophilic groups, e.g. enzymes or proteins.

U.S. Pat. No. 5,904,848 (Wong et al.) discloses a porous membrane composed of a normally solid thermoplastic synthetic resin, e.g. polytetrafluoroethylene, and a controlled pore glass. The surface of the membrane is modified, for example, by silanization to provide functional groups (e.g., amino, hydroxyl, carboxyl, epoxide, aldehyde, phenyl) for the binding of biological moieties such as cells and biomolocules.

U.S. Pat. No. 6,686,479 (Bruening et al.) describes a method of separation of amine or aminoacid enantiomer from its counter-enantiomer with the aid of a selective binding material. Said material is composed of at least one ligand covalently bonded to a particulate solid support through a hydrophilic spacer having the formula SS-A-X-L coated with a hydrophobic organic solvent. In the above-mentioned formula SS is a porous or non-porous particulate inorganic or organic polymer solid support, A is a covalent linkage mechanism, X is a hydrophilic spacer grouping, and L is a bisnaphthyl crown ether ligand molecule having at least two naphthyl groups.

The entire contents of the hereinabove- and hereinbelow-mentioned US Patents and published US Patent Applications are incorporated herein by reference.

### OBJECTS OF THE INVENTION

An object of the present invention is to overcome the disadvantages of the above prior art by providing a composite membrane comprising a porous vacuum-deposited ceramic layer, supported by a porous substrate.

Another object of the invention is to provide such a composite membrane, which includes additionally at least one metallic (e.g., palladium alloy) permselective layer and has high flux and high selectivity with respect to hydrogen in its separation from gaseous mixtures.

Yet another object of the present invention is to provide a composite membrane for separations in fluid systems (containing gases, liquids, ions, etc.), which membrane has high flux and high selectivity with respect to permeate.

Still another object of the present invention is to provide a composite membrane for separation in fluid systems, which membrane comprises a sandwich-like multi-layer system, containing more than one ceramic layer and more than one metallic layer, disposed on a porous substrate.

A further object of the present invention is to provide a composite membrane for separation in fluid systems, which membrane comprises a substrate, a ceramic layer and a selective sorbent layer.

Yet a further object of the present invention is to provide a composite membrane as described above, exhibiting improved mechanical strength and resistance to thermal stresses.

A still further object of the invention is to provide a membrane suitable for use as a plate in thin layer chromatography.

In the present invention the term “separation” is intended to encompass any separation effected with the aid of a membrane of at least one kind of targeted molecules, ions or biological species in its mixtures with other kinds of molecules, ions or biological species, or alternatively releasable or non-releasable immobilization (isolation) by the membrane of the aforementioned targeted molecules, ions or biological species.

### SUMMARY OF THE INVENTION

In a first aspect, the present invention provides a composite membrane adapted for separation of components of fluid mixtures, and which includes a porous, essentially continuous, vacuum-deposited ceramic layer, supported by a porous substrate, the ceramic layer comprising at least one metal oxide selected from the group consisting of oxides of aluminum, titanium, tantalum, niobium, zirconium, silicon, thorium, cadmium and tungsten, wherein the average width of the pores of the substrate is greater than that of the pores of the ceramic layer, and at least one of the following conditions is fulfilled, namely:

(a) the ceramic layer has a fractal surface structure;
(b) the ceramic layer consists essentially of a mixture of metal(s) and oxide(s) thereof;
(c) the membrane has sufficient flexibility enabling it to be rolled up and unrolled;
(d) there is disposed on the surface of the ceramic layer a vacuum-deposited metallic layer, wherein the porosity and (or) average pore width of the metallic layer is less than the porosity and average pore width of the ceramic layer.

In this membrane, the substrate operates as a mechanical support for the membrane which will allow free flow of fluid therethrough. The substrate generally defines obverse and reverse sides and the supported ceramic layer is disposed either on one side only, or on both sides, of the substrate. Where the supported ceramic layer is disposed on one side only of the substrate, there is preferably disposed on the surface of the ceramic layer a vacuum-deposited metallic layer, wherein the porosity and (or) average pore width of the metallic layer is less than the porosity and (or) average pore width of the ceramic layer. Where the supported ceramic layer is disposed on both sides of the substrate, thus defining two ceramic layer surfaces, there is preferably disposed on at least one of the two surfaces, a vacuum-deposited metallic layer or layers, wherein the porosity and (or) average pore width of the metallic layer(s) is less than the porosity and average pore width of the ceramic layer.

Preferably, in the above-described membrane, at least one of the following further conditions is fulfilled, namely:

(i) the vacuum-deposited ceramic layer has been deposited by physical vapor deposition (PVD);
(ii) the substrate is a metallic substrate;
(iii) the ceramic layer has a fractal surface structure selected from dendrite, cauliflower-like and coral-like fractal surface structures;
(iv) the ceramic layer consists essentially of a mixture of aluminum metal and alumina;
(v) the supported ceramic layer is disposed on both sides of the substrate, and both ceramic sides being also bonded to each other through the pores of the substrate, thereby imparting improved mechanical strength to the membrane.

More preferably in the above membrane, the substrate is selected from stainless steel mesh and etched aluminum foil.

In a modification of the membrane of this aspect, optional metallic layer(s) is (are) replaced with sorbent layer(s). The sorbent layer(s) selectively sorb(s) at least one component of the separated mixture, or alternatively selectively bind(s) to the species of at least one component of the separated mixture. An example of the latter case is affinity chromatography, where an affinity ligand, specific for a binding site on the target molecule, is coupled to an inert chromatography matrix.

Materials of the sorbent layer can be, for example, zeolites (in the case of usual adsorption) or amino acid resins (in the case of adsorption based on the affinity principle). In this modification of the membrane, the substrate of the membrane is not restricted in view of its porosity and pore width.

In a second aspect, the invention provides a composite membrane adapted for separation of components of fluid mixtures, and which includes a multi-layer system of at least two porous, essentially continuous, vacuum-deposited ceramic layers. Such ceramic layers are disposed on at least one side of, and supported by, a porous substrate, the ceramic layers comprising at least one metal oxide selected from the group consisting of aluminum, titanium, tantalum, niobium, zirconium, silicon, thorium, cadmium and tungsten oxides, wherein between any successive ceramic layers, there is disposed a vacuum-deposited metallic layer wherein the porosity and (or) average pore width of the metallic layer is less than the porosity and (or) average pore width of the ceramic layer, at least one of the following conditions also optionally being fulfilled, namely:

(a) at least one ceramic layer has a fractal surface structure;
(b) the ceramic layer consists essentially of a mixture of metal(s) and oxide(s) thereof;
(c) the membrane has sufficient flexibility enabling it to be rolled up and unrolled;
(d) there is disposed on the surface of any outermost ceramic layer a vacuum-deposited metallic layer, wherein the porosity and (or) average pore width of the metallic layer is less than the porosity and (or) average pore width of the outermost ceramic layer.

In a particular embodiment of the membrane which includes a multi-layer system, the membrane is disposed on one side only of the substrate, and optionally, a single ceramic layer as defined in claim 9 hereinbelow is disposed on the other side of the substrate and is supported thereby. Preferably, in this embodiment, there is disposed on the surface of one or both outermost ceramic layer(s) a vacuum-deposited metallic layer, wherein the porosity and (or) average pore width of the metallic layer is less than the porosity and (or) average pore width of the outermost ceramic layer(s).

In an alternative embodiment, the multi-layer system is disposed on both sides of the substrate. Preferably, in this embodiment, there is disposed on the surface of at least one of the two outermost ceramic layers, a vacuum-deposited metallic layer or layers, wherein the porosity and (or) average pore width of the metallic layer(s) is less than the porosity and (or) average pore width of the outermost ceramic layer(s).

The features (i) through (v), enumerated above, may also optionally be applied to the composite membrane which includes the multi-layer system. Preferred substrates for this membrane are also stainless steel mesh or through-hole type etched aluminum foil.

In another aspect, the invention provides a membrane adapted as a plate for thin layer chromatographic identification and(or) separation of components of fluid mixtures, and which includes a single porous, essentially continuous, vacuum-deposited ceramic layer, disposed on at least one side of, and supported by, a non-porous substrate, the ceramic layer comprising at least one metal oxide selected from the group consisting of aluminum, titanium, tantalum, niobium, zirconium, silicon, thorium, cadmium and tungsten oxides, wherein, optionally, at least one of the following conditions is also fulfilled, namely: (α) the ceramic layer includes at least one rare earth metal; (β) the ceramic layer has a fractal surface structure; (γ) the non-porous substrate is selected from aluminum and polymeric substrates; (δ) the membrane has sufficient flexibility enabling it to be rolled up and unrolled.

In still another aspect, the invention provides a membrane in roll form adapted as a filling for a chromatographic column, which includes a single porous, essentially continuous, vacuum-deposited ceramic layer, disposed on at least one side of, and supported by, a porous or non-porous substrate, the ceramic layer comprising at least one metal oxide selected from the group consisting of aluminum, titanium, tantalum, niobium, zirconium, silicon, thorium, cadmium and tungsten oxides, wherein, optionally, at least one of the following conditions is also fulfilled, namely: (α) the ceramic layer includes at least one rare earth metal; (β) the ceramic layer has a fractal surface structure; (γ) the non-porous substrate is selected from aluminum and polymeric substrates.

### BRIEF DESCRIPTION OF THE DRAWINGS

FIG. 1 is a schematic cross-sectional view of an embodiment of the composite membrane of the invention, with ceramic and metallic layers.

FIG. 2A is a schematic cross-sectional view of an embodiment of the composite membrane of the invention, with a ceramic permselective layer having a cauliflower structure.

FIG. 2B is a schematic cross-sectional view of an embodiment of the composite membrane of the invention, with a metallic permselective layer disposed on a ceramic layer having a cauliflower-like structure.

FIG. 2C is a SEM micrograph (top view) of the ceramic layer having a cauliflower-like structure produced by the method described hereinbelow in Example 4.

FIG. 3A is a SEM-micrograph (cross-sectional view) of the ceramic layer having a dendrite structure, produced by the method described hereinbelow in Example 1.

FIG. 3B is an example of a SEM-micrograph (cross-sectional view) of the ceramic layer having a coral-like structure.

FIG. 4A is a schematic cross-sectional view of an embodiment of the composite membrane of the invention with a ceramic layer and a selective sorbent layer.

FIG. 4B is a schematic cross-sectional view of an embodiment of the composite membrane of the invention, with a multi-layer system.

FIG. 5 is a schematic perspective view and a cross-section of a membrane element of the spiral-wound type, incorporating a composite membrane of the present invention.

FIG. 6 is a schematic cross-sectional view of the membrane element of the spiral-wound type described in FIG. 5, placed in a pressure casing.

FIG. 7 is a schematic cross-sectional view of a membrane module of the tubular type, incorporating a composite membrane of the present invention.

FIG. 8 is a pore width distribution chart of the ceramic layer having a dendrite structure, produced by the method described hereinbelow in Example 1.

FIGS. 9A and 9B present a top view of a composite membrane having a ceramic cauliflower-like layer disposed on a stainless steel mesh substrate, obtained with an optical microscope at a magnification of 700 and 1100, respectively.

FIG. 10 is a pore width distribution chart of the ceramic layer having a cauliflower-like structure, produced by the method described hereinbelow in Example 2.

FIG. 11 is a SEM-micrograph (cross-sectional view) of the ceramic layer having a dendrite structure, produced by the method described hereinbelow in Example 3.

FIG. 12 is a pore width distribution chart of the ceramic layer having a dendrite structure, produced by the method described hereinbelow in Example 3.

FIG. 13 is a pore width distribution chart of the ceramic layer having a cauliflower-like structure, produced by the method described hereinbelow in Example 4.

FIG. 14 is a general scheme of an apparatus for continuous manufacture of long rolled webs of the composite membranes of the present invention.

### DETAILED DESCRIPTION OF THE INVENTION

As has been stated above, in the membrane according to the invention, the substrate generally defines obverse and reverse sides. This means that in general, the substrate, considered as a three-dimensional object, will have a configuration in which two dimensions are much greater than the third dimension, as in e.g. a foil or plate, or a self-supporting film. However, this laminar nature of the substrate does not preclude such configurations as hollow geometrical shapes such as tubes, cylinders and helices, as well as spiral-wound substrates.

Where the ceramic layer consists essentially of a mixture of metal(s) and oxide(s) thereof, such mixture imparts additional mechanical strength to the ceramic layer. In the embodiments where the composite membrane includes a layer of metal on the surface of the ceramic layer, the metal can be e.g. palladium, or an alloy of palladium with other metals such as those mentioned previously herein. Where the substrate is stainless steel mesh or aluminum foil, these are examples of substrates which can impart to the composite membrane sufficient flexibility enabling it to be rolled up and unrolled.

Typically, the ceramic layer of the membrane of the present invention has a structure which is characterized by a relatively wide range of pore width, i.e. possessing diverse pore widths. An example of such a layer is a fractal structured layer, which can be e.g. of dendrite, cauliflower-like or coral-like types.

In the aspect of the composite membrane of the invention which includes a multi-layer system, this system comprises more than one ceramic layer and at least one metallic layer; the metallic layer(s) and the ceramic layers are arranged in such a manner that each ceramic layer and each metallic layer are alternated. The metallic layer, if applied, can be either porous or non-porous (dense). Both the ceramic layer and the metallic layer, if present, are applied by a vacuum deposition technique.

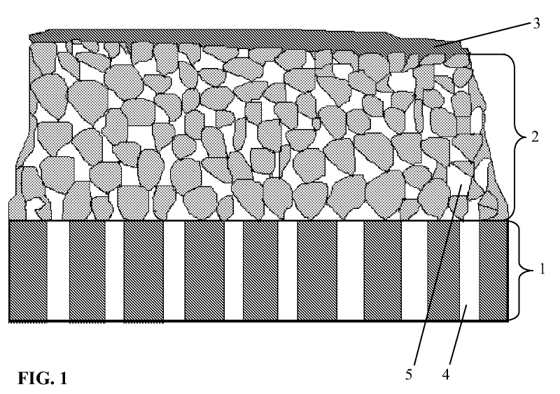

The structure of the composite membrane according to the first aspect of the invention is illustrated schematically by FIG. 1, where 1 denotes a porous substrate, 2 denotes a porous ceramic layer, 3 denotes an optional metallic layer, 4 represents a pore of the substrate, and 5 represents a pore of the ceramic layer.

In an embodiment of the membrane with metallic layer(s) at least one of the ceramic or metallic layers is a permselective layer, that is a layer responsible for selective permeability therethrough of at least one component of the mixture and retention of the rest of the components (or single component). In a modification of the membrane with sorbent layer(s) the separation mechanism differs in that the sorbent layer(s) selectively sorb(s) the targeted component(s) or biological specie(s) thus separating them from other components or immobilizing them on the binding surface.

As mentioned above, the ceramic layer comprises at least one metal oxide selected from the group consisting of oxides of aluminum, titanium, tantalum, niobium, zirconium, silicon, thorium, cadmium and tungsten and is produced by a vapor deposition technique. In the present invention, metal oxide(s) of the ceramic layer is (are) produced as a result of a chemical reaction occurring in the vacuum environment between a metal which is converted from the solid phase to the vapor phase, e.g. by thermal evaporation, and an oxidizing agent, e.g. gaseous mixture comprising oxygen. Thus the process that we call “deposition” comprises the following stages: changing the state of the metal from the solid phase to the gaseous phase, chemical reaction, and the deposition stage proper. The process conditions can be chosen so as to produce a coating composed of metal oxide(s) only, or a coating composed of a mixture of metal oxide(s) with metal(s). Thus, in addition to metal oxides the ceramic layer can contain metals, such as aluminum, titanium, tantalum, niobium, zirconium, silicon, thorium, cadmium and tungsten. Metal component(s) of the ceramic coating may improve its mechanical strength, and as a result the mechanical strength of the entire membrane. The preferable material of the ceramic layer is aluminum oxide (alumina) or a mixture of alumina with aluminum.

The substrate of the composite membrane can be a metal substrate, either rigid or flexible. In the latter case, the composite membrane desirably exhibits sufficient flexibility enabling it to be rolled up and unrolled. The flexibility of the membrane enables its usage in compact membrane elements, e.g. of spiral-wounded type and in long (1 to 3 meters length) tubular membrane elements.

In the membrane according to the first aspect of the invention as defined above, various embodiments are possible. Thus, for example, in absence of any metallic layer, it is the ceramic layer that performs a permselective function. On the other hand, when the membrane includes a metallic layer, this layer may be permselective, while the ceramic layer can be also permselective, or serve merely as a support for the metallic layer. It may be noted that in certain embodiments, the ceramic layer may effectively operate as a barrier for preventing intermetallic diffusion. Typical materials for the metallic layer are e.g. palladium, palladium-silver alloy, and palladium-cooper alloy.

As to the sorbent layer, the mechanism of its functioning, the methods of its deposition and possible materials will be discussed further below.

As pointed out above, the ceramic and the metallic layers are fabricated by a vacuum deposition technique, e.g. physical vapor deposition (PVD) including thermal evaporation, electron-beam evaporation, sputtering, or by e.g. chemical vapor deposition. Both layer types (ceramic and metallic) can be produced by the same deposition technique, or by different deposition techniques.

In a particular embodiment, the ceramic layer is disposed on both sides of the substrate thus defining two ceramic layer surfaces, both ceramic layers being also bonded to each other through the pores of the substrate, thereby imparting improved mechanical strength to the composite membrane. Optionally, a metallic layer can be disposed on only one ceramic surface, or on both of them. The metallic layer(s) have a lesser porosity and (or) average pore width than that of the ceramic layer, and this characteristic includes also dense (micro-porous) metallic layers.

The deposition of the ceramic layer on the second side and the optional deposition thereon of the metallic layer or the sorbent layer is performed similarly to the deposition on the first side of the substrate. The properties (composition, structure, porosity, average pore width, thickness, etc.) of the ceramic and metallic (or sorbent) layer deposited on the second side of the substrate can be either same, or different from those of the layers deposited on the first side.

The metallic layer, when present, generally bears the burden of the permselectivity function, and therefore should be as thin as possible to ensure maximum flux of the permeate component or components of the mixture (e.g. hydrogen in the steam reforming process), since the flux is inversely proportional to the membrane thickness. Preferably, the metallic layer of the membrane of the present invention is dense (non-porous), but a micro-porous metallic layer having a pore volume less than the ceramic layer is also applicable.

When the ceramic layer (or layers) functions as support for one or more metallic layers, the ceramic layer should be mechanically as strong as possible. Additionally, the ceramic layer should meet the following requirements. Its surface must be as smooth as possible in order to support well a very thin metallic layer. If the support has a rough surface (with relatively big size of the surface irregularities, “peaks” and “valleys”), a thin metallic layer will tend to collapse into the “valleys” of the surface. On the other hand, the ceramic support must be sufficiently porous in order not to reduce significantly the flux of the permeate component or components. Typically, the techniques used so far for increasing porosity of materials, are directed to the increase of the surface area by producing irregularities on the surface. Examples of applications which employ these techniques are lithographic printing plates, electrodes for electrolytic capacitors, and many others. However, such techniques, being applied to the ceramic layer, would result in a surface with irregularities of relatively big size, thereby contradicting the requirement of a substantially smooth surface. In the present invention the two foregoing contradictory requirements are reconciled in the following way.

In the present invention, a ceramic support for the metallic layer is implemented in the form of a coating fabricated by a vacuum deposition technique. It is known in the art that vacuum deposition techniques can fabricate coatings with the desired surface structure (morphology). More specifically, it is possible to control the structure of the coating by the appropriate selection of raw materials (e.g., metals, oxidizing agents) and process conditions (flow and composition of the oxidizing agent, pressure, etc.). In the present invention, the raw materials and the process conditions are selected so as to preferably impart a fractal surface structure to the ceramic layer, that is, a surface composed of fractals. Fractals are unusual, difficultly defined, mathematical objects which observe self-similarity, so that the parts are somehow self-similar to the whole. This self-similarity feature implies that fractals are essentially scale-invariant—you cannot in principle distinguish a small part from the larger structure, e.g. a tree branching process.

Coatings having fractal structures are described in the prior art, e.g. U.S. Pat. No. 6,933,041 and U.S. Pat. No. 6,764,712 (both Katsir et. al), U.S. Pat. No. 5,571,158 (Bolz et al), U.S. Pat. No. 6,974,533 (Zhou), U.S. Pat. No. 6,994,045 (Pazkowski). For example, U.S. Pat. No. 6,933,041 teaches a porous coating, produced by a vacuum deposition technique, composed of a mixture of valve metal and its oxide. The described coating has a fractal structure, particularly, a cauliflower-like structure and is used in applications where high surface area of the substrate is required, e.g. electrodes of electrolytic capacitors.

Coatings with a fractal surface structure are characterized by pores of diverse width in the sense that the width of the pore canal covers a relatively wide range of values. Based on this feature the inventors consider fractal-structured coatings (ceramic layers) as ideal candidates to serve as a support for the metallic layer(s) or sorbent layer(s) of the composite membrane of the present invention. In embodiments with metallic layer(s) pores of relatively small width, on the one hand, facilitate the disposal of the particles of the metallic layer(s) on the supporting ceramic layer(s). This means that the fine structure of the surface of the ceramic layer(s) permits a deposition thereon of extremely thin films of the metallic layer(s) and ensures good adhesion of the metallic layer(s) to the ceramic layer(s). On the other hand, the layer with a fractal-like structure also contains pores of relatively large width, therefore, such a layer does not reduce significantly the flux of permeate, e.g. hydrogen. As to the embodiment with sorbent layer(s) relatively small (in view of the width) pores of the ceramic layer(s) facilitate an adhesion of the affinity ligands, while relatively big (in view of the width) pores facilitate binding of the species of the bound material.

Unlike fractal-structured coatings of the cited prior art, the fractal structure of the layers (coatings) of the present invention is used not primarily for increasing the surface area of a coating, but rather for producing a surface structure having diverse pore canal widths.

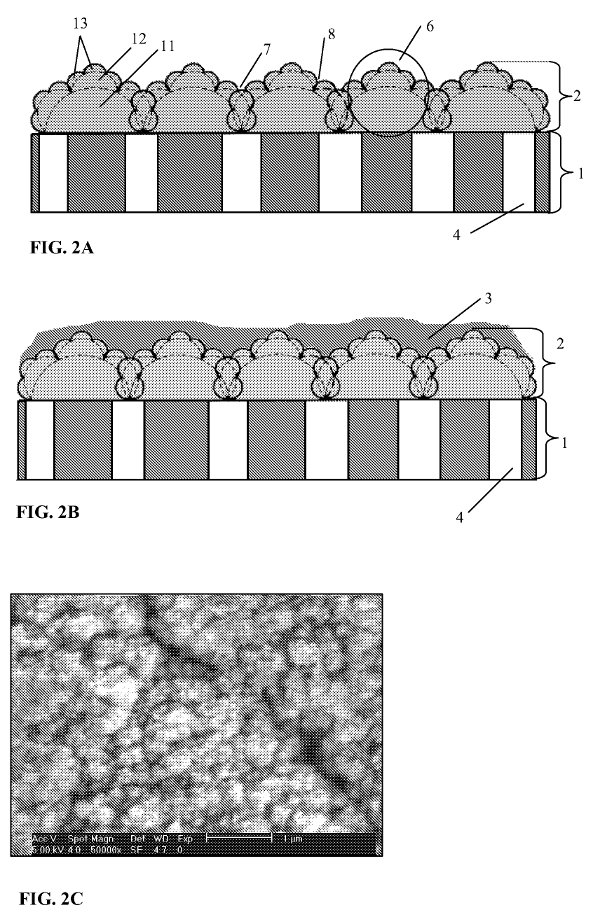

The fractal-structured coatings can be better understood from the following explanation, in which a certain type of fractal structure, namely the cauliflower-like structure, is taken as an example. The membranes with cauliflower-like structure of the ceramic layer are schematically illustrated by FIGS. 2A-C, in which FIG. 2A shows the membrane without a metallic layer, FIG. 2B shows the membrane with a metallic layer, and FIG. 2C shows a SEM micrograph (top view) of the ceramic layer with a cauliflower-like structure deposited on a through-hole type etched aluminum foil.

In FIGS. 2A and 2B, numerals 1 to 4 designate the same elements as in FIG. 1. It may be noted, that the described structure is characterized by a plurality of cauliflower “bodies” 6. Voids, i.e. spaces within the coating which are not filled by the cauliflower “bodies” are illustrated by pores 7 and 8 of different size. Each “body” consists of a “head” 11 and “florets” 12, the “florets” are branched off the “head” to which they are attached. Each “floret” 12 in its turn has smaller “florets” 13, etc. Thus, the structure is characterized in that each child floret is self-similar to its parent (i.e., the floret to which it is attached). Each cauliflower “head” 11 can be considered as a grand parent with respect to the floret of any level (generation). The described structure resembles a tree structure in which the trunk of the tree corresponds to the head of the cauliflower, and the branches of the tree correspond to the florets.

It is clear from the foregoing description that the cauliflower-like structure is characterized by the florets of diverse width and by pores of diverse width. Such ceramic coatings can serve as an excellent support for a metallic layer deposited thereon. Small florets, being located in the upper sub-layer, form a relatively smooth surface, which ensures good adhesion of the metallic layer. As a result, the prior art problem of delamination of the permselective layer from its supporting surface, is avoided. On the other hand, big heads, being located in a lower sub-layer, ensure mechanical strength of the support. Thus, an asymmetric structure of the support, which includes pores of diverse width, is preferred. Narrow pores form a relatively fine smooth surface on the coating, while wide pores being located between the cauliflower heads, form relatively straight canals, oriented substantially in the transverse direction. Relatively straight, wide pores oriented in the transverse direction do not substantially reduce the flux of hydrogen.

The foregoing structure permits deposition, onto the surface of the ceramic layer, an extremely thin layer of metallic material (metal or metal alloy) and ensures good adhesion of the metallic layer to the ceramic layer. Thus, the coating with a cauliflower-like surface structure can serve as an ideal support for a thin metallic layer, because narrow pores contribute to the smoothness of the surface, while wide, and substantially straight pores, having low hydrodynamic resistance, contribute to the flux of hydrogen.

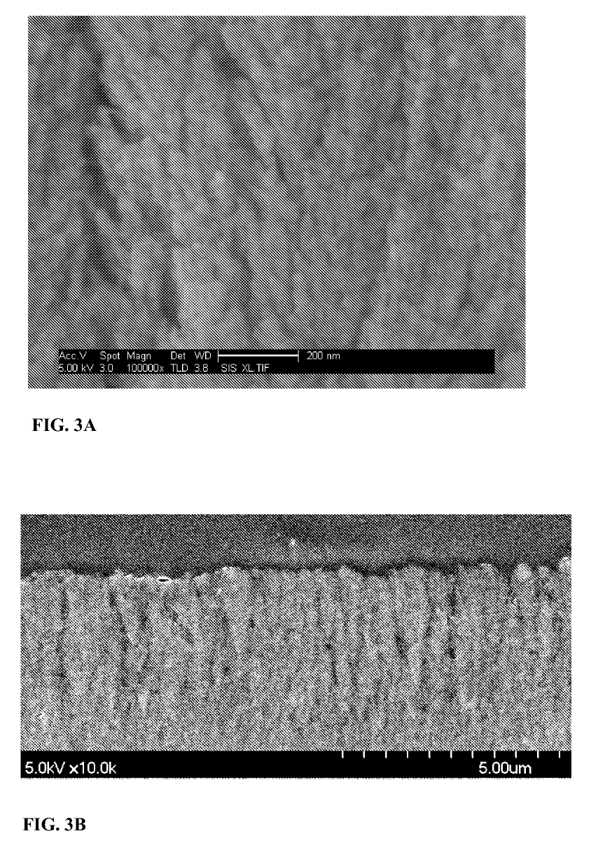

Other fractal structures of the ceramic vacuum deposited coatings of the present invention may be of dendrite (FIG. 3A) and coral-like (FIG. 3B) types. It is noted that the geometric shape of fractals (i.e., fractal “bodies”) for dendrite and coral-like types are different from each other and from the cauliflower-like type, but all three types of structure are characterized by self-similarity.

The preferred material for the ceramic layer is aluminum, or an aluminum/alumina mixture, in which alumina can be either in γ-modification or in α-modification. However, other materials capable of forming a layer with similar properties (mechanical strength, surface structure, etc.) can be used alternatively.

The metallic layer, when present in the composite membrane of the present invention, may be composed of e.g., Pd, Group V metals, or their alloys with other metals. In a particular embodiment, the metal is palladium-silver alloy, preferably containing e.g. 23% by weight of palladium. In another embodiment, the metal is a palladium-copper alloy, preferably containing 40% by weight of copper. Alloys containing three or more components can be also used, e.g. Pd—Ru—In.

The metallic and ceramic layers may be deposited, e.g. by one of the following vacuum deposition techniques: thermal evaporation, e-beam evaporation, sputtering, or chemical vapor deposition. Different deposition techniques can be employed for depositing different layers, for example vacuum evaporation and sputtering. If a sputtering technique is used for the deposition of an alloy (in the case of a metallic layer), it can be deposited as a single component (that is from one target), or alternatively distinct targets can be used for distinct deposition of each component of the alloy. The deposition from distinct targets is especially advantageous, when an alloy of special composition, which is not manufactured by the industry, is required. The process of distinct deposition of alloy components enables the use of alloys with a predetermined composition, in which the alloy is fabricated not prior to, but simultaneously with the deposition process.

It will be appreciated by those skilled in the art, that the materials for the metallic and the ceramic layers are not limited to the above-mentioned metals, metal oxides and metal alloys. For example, any material which is capable of being applied by a vacuum deposition technique and has similar characteristics in view of selectivity and flux with respect to particular permeates (e.g. hydrogen) can also be used for a metallic layer. As to the ceramic layer, any material, within the definition herein, which is capable of forming a fractal structure with similar characteristics (width of heads and florets, pore width distribution, etc.) also can be used.

The substrate, which is an essential element of the composite membrane of the invention, should be desirably mechanically strong and flexible.

Additionally, the pores must be relatively wide to allow permeate to pass readily through the substrate, but not too wide to detract from adequate support of the ceramic layer. In view of these desired properties, a stainless steel mesh and a through-hole type etched aluminum foil are preferably used. In the case of stainless steel mesh, the preferred characteristics of the substrate are as follows: (a) thickness between 36 μm and 42 μm, more preferably 38±2 μm; (b) aperture size between 33 μm and 41 μm, more preferably 46 μm; (c) strand width less than 30 μm, more preferably 18 μm; and (d) open area is between 42% and 52%, more preferably 51%.

The material of the substrate is not essentially limited to the foregoing materials. Any porous material which has similar properties (flexibility, mechanical strength, thickness, aperture size, etc.) also can be used.

The preferred thickness of the metallic layer(s) is between 0.05 and 2 μm, more preferably between 0.1 and 0.5 μm; the preferred thickness of the ceramic layer(s) is between 5 and 40 μm, more preferably between 10 and 20 μm.

In a modification of the membrane of this aspect, optional metallic layer(s) is (are) replaced with sorbent layer(s). Said sorbent layer(s) selectively sorb(s) at least one component of the separated mixture (e.g. in the case when the sorbent layer is made of zeolite), or alternatively, selectively bind(s) to the species of at least one component of the separated mixture (e.g. in the case when the sorbent layer is an amino acid resin). The selective binding can be either releasable, that is the selectively bound substance or biological specie can be further released, e.g. by elution, or non-releasable. As mentioned above, typical application of a biological separation based on the principle of selective binding is affinity chromatography, which is widely used in biological separations, including immobilization (isolation) of the targeted species. Typically, the substances which can be separated or immobilized with the membrane of this modification are proteins, nucleic acids, polysaccharides, lipids, terpenoids, etc, or biological species. Other possible applications of this membrane are ion-exchange chromatography and bioreactors. When used as a bioreactor, for example, an enzyme may be affixed to the activated sites on the membrane, either directly or through a ligand. A carrier liquid containing the substance to be lysed is then passed through the membrane so that the bound enzyme acts upon such substance.

Unlike the membranes of the previously disclosed embodiments, the substrate of the membrane of this embodiment is not restricted in view of its porosity and pore width. In other words, the substrate can be either porous with unrestricted porosity and pore width or non-porous (dense). An example of a dense substrate is a conventional metallic foil, e.g. aluminum foil.

Similar to the metallic layer of the membrane of previously described embodiments, in this embodiment the selective sorbent layer can be disposed on one or both ceramic surfaces. A membrane having selective sorbent layers on both the obverse and reverse sides enhances its sorbent capability by a factor of 2.

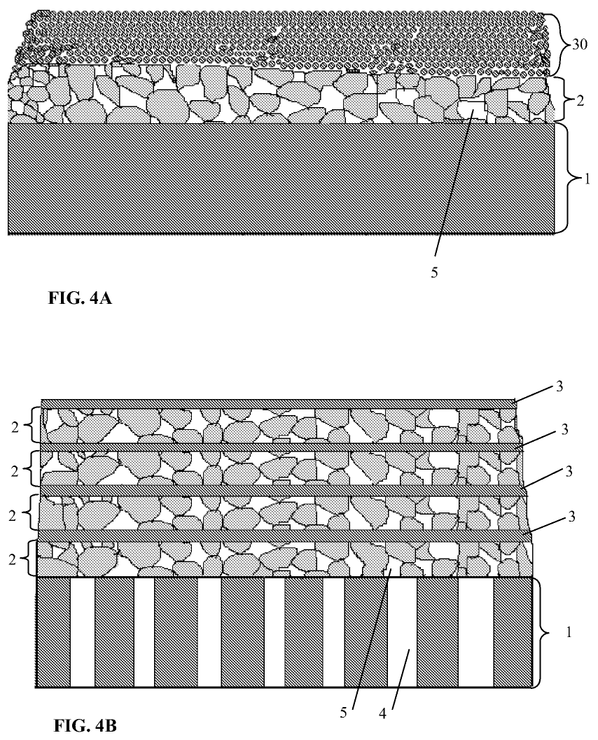

FIG. 4A illustrates an exemplary membrane according to this embodiment with a single selective sorbent layer, in which numeral 30 designates the sorbent layer, numeral 1 designates a substrate, which in this embodiment can be dense or porous, and other numerals have the same meanings as in FIG. 1. A material of the sorbent layer can be, for example, zeolite. In such a case, the membrane is capable of separating, for example, arabinose from its aqueous mixture with ketoses and (or) other aldoses. In the case wherein the sorbent layer comprises a substance which selectively binds to the species of at least one component of the mixture, the membrane according to this modification can be used for a separation, for example, by the method of batch affinity chromatography. Examples of the aforesaid selectively-binding substance include amino acid resins (e.g. L-Lysine Agarose Lyophilized powder), avidin biotin matrices (e.g., EZview™ Red Streptavidin affinity gel), chelating resins (e.g., Tris [Carboxymethyl] Ethylenediamine-Agarose lyophilized powder), and other materials known in the art. The foregoing materials are known in the prior art as affinity ligands.

The technique used for depositing the sorbent material on the surface of the ceramic layer(s) depends upon the properties of the material to be deposited. For example, zeolite particles can be applied by electrophoretic deposition, affinity ligands can be applied by surface modification, as, for example, disclosed in U.S. Pat. No. 5,904,848. The preferable thickness of the ceramic layer(s) of the membrane according to this modification is 5 to 10 μm, while preferable thickness of the selective sorbent layer(s) is 5 to 100 μm. More preferable thickness of the selective sorbent layer(s) depends upon the application of the membrane.

In the composite membrane of the invention which includes a multi-layer system (i.e. containing more than one metallic layer and more than one ceramic layer), such system may be illustratively disposed on substrate 1 (FIG. 4B). In this system, there is disposed a metallic layer 3 between any successive ceramic layers 2. Numerals 4 and 5 designate the same elements as in FIG. 1. The porosity and (or) average pore width of the metallic layer is less than that of the adjacent ceramic layers; this includes the case where the metallic layers are non-porous (dense). The ceramic and metallic layers are produced by a vacuum deposition technique, as elaborated above.

The multi-layer structure reduces the risk of selectivity decrease, in the case where micro-cracks or (and) pinholes are formed in the metallic layer(s). Since all the metallic layers are independent from each other, each layer can be considered as a back-up layer for the case of micro-cracks or(and) pinholes. The multi-layer system may also reduce the risk of de-lamination of the layers, because the ceramic layers bind the interleaved metallic layers. Furthermore, both ceramic layers being bonded to each other through the pores of the substrate imparts improved mechanical strength to the composite membrane.

In the composite membrane including the multi-layer system, the following conditions are optionally fulfilled: at least one ceramic layer has a fractal surface structure (e.g. dendrite, cauliflower-like or coral-like); the membrane has sufficient flexibility enabling it to be rolled up and unrolled; there is disposed on the surface of any outermost ceramic layer a vacuum-deposited metallic layer, which is non-porous or has a porosity lower than that of the outermost ceramic layer.

The multi-layer system can be disposed on one side only of the substrate (as shown in FIG. 4B), or on both sides. The deposition on the second side is optional and is performed similarly to the deposition on the first side of the substrate. The number and the thickness of layers disposed on the second side of the substrate can be either the same, or different from those of the layers disposed on the first side. This also holds true for the materials of the ceramic and (or) metallic layers and properties in the layers (structure, porosity, pore width distribution, etc.).

In a particular embodiment, the membrane comprises a multi-layer system disposed on one side of the substrate and a ceramic layer disposed on the other side of the substrate. Optionally, a metallic layer can be disposed on the outmost ceramic layer of one side only, or on both sides.

As regards the materials and the properties of the metallic layers, the ceramic layers and the substrate, the membrane including the multi-layer system is similar to the membrane of the first aspect of the invention. However, the metallic and ceramic layers of the multi-layer membrane are thinner than the corresponding layers of the membrane of the first aspect of the invention. A preferable thickness of the metallic layers is between 0.01 and 1 μm, more preferably between 0.05 and 0.2 μm; the thickness of the ceramic layers is between 0.2 and 5 μm, preferably between 0.5 and 1 μm. The pore volumes of the ceramic and metallic layers are similar in the membranes of both aspects of the invention.

The composite membrane of the present invention can be manufactured in the form of flexible sheets or in the form of continuous long rolled webs. Typically, the membranes in the form of sheets are produced in an apparatus operating in a batch mode, while the membranes in the form of continuous rolled webs are typically produced in an apparatus operating in a continuous mode. In the latter case, different deposition techniques, for example vacuum evaporation and sputtering, can be employed for depositing ceramic and metallic layers, even under different degrees of vacuum. Moreover, in the case of membranes comprising more than one ceramic layer and (or) more than one metallic layer—for example, membranes in which the ceramic and (or) the metallic layers are disposed on both sides of the membrane, or membranes comprising the multi-layer system—different ceramic and (or) different metallic layers can be deposited using different deposition techniques.

The composite membranes with ceramic layer(s) only and with ceramic and metallic layer(s) can be incorporated mainly, but not mandatory, in membrane elements of the tubular type, spirally wound type, or plate-and-frame type.

For example, in the spiral wound element the composite single-sided membrane is spirally wound around a perforated hollow pipe. Such design ensures high values of the membrane surface area to unit of assembly volume ratio.

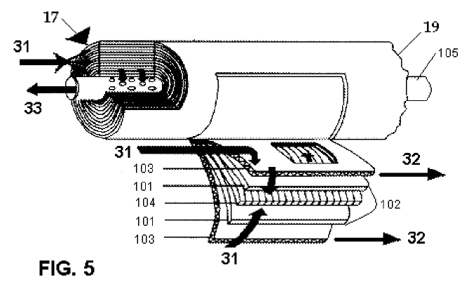

The spirally wound membrane element comprises a plurality of membrane envelopes 102 separated by feed spacers 103 (FIG. 5). The plurality of membrane envelopes 102 with feed spacers 103 therebetween are spirally wound around the outer peripheral surface of a perforated hollow pipe 105 closed from one end. Each membrane envelope consists of two composite membranes 101 and encases permeate spacer 104. Spacers 103 and 104 are used for preventing the membranes 101 from coming into close contact with each other. Feed spacers 103 form a passage for the feed, while permeate spacers 104 form a passage for the permeate. The membrane element operates in the following way: the feed mixture 31 is introduced into the wrapped membrane from one of its ends, e.g. from end 17. The permselective component (or components) permeate(s) through the composite membranes 101 and infiltrates through the clearances between membranes 101 along spacers 104. Permeate 33 is removed via the opened end of the pipe, while retentate 32 is withdrawn from the end of the wrapped membrane opposite to the feed inlet, e.g. 19. The composite membranes applied in this design are single-sided membranes with a ceramic layer and an optional metallic layer.

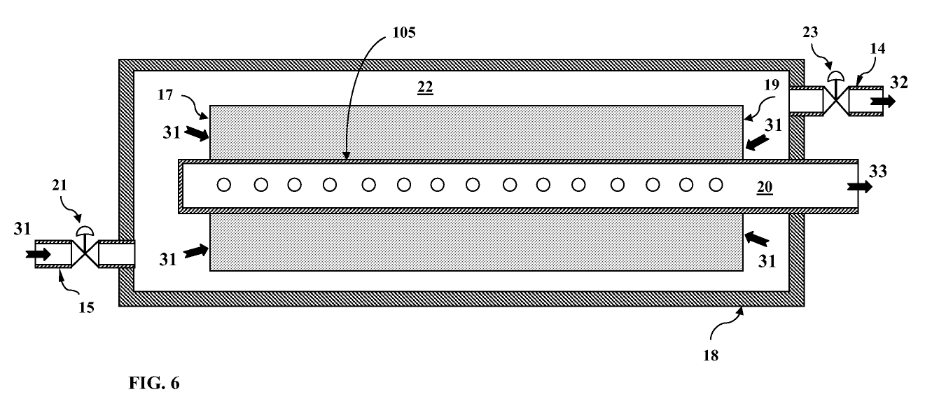

In another design the membrane element is placed in a pressure casing 18 (FIG. 6). The separation process includes two steps: permeation of the selective component (or components) and withdrawal of the retentate. In the permeation step, feed 31 is introduced under pressure through inlet 15 of casing 18, when valve 21 is opened, and valve 23 is closed. The feed mixture enters into the membrane element mainly through its ends 17 and 19. The permselective component (or components) of the mixture permeate(s) through the membrane and is (are) taken from the region 20 of pipe 105. On the step of retentate withdrawal valve 21 is closed, while valve 23 is opened, and the retentate 32 is withdrawn from space 22 between the membrane element and the casing via outlet 14.

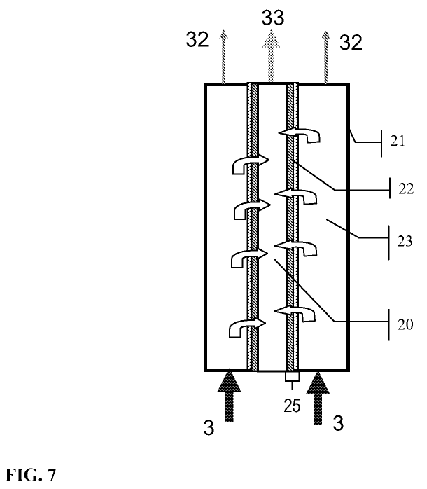

If a membrane element of the tubular type is applied, it is placed in the tubular pressure casing, thereby forming a membrane module. The membrane element of tubular type comprises composite membrane 25 in the form of a flexible sheet or roll (FIG. 7). The module comprises two concentric tubes: outer tube 21 (casing) and inner perforated tube 22. The inner tube is wrapped from its outer peripheral surface with the composite membrane 25. Feed 31 is introduced under pressure from one end of the module in annulus 23. The permselective component 33 (or components) penetrate(s) through the membrane and is (are) removed from permeate section 20. Retentate 32 is removed from annulus 23 from the opposite end of the module. The composite membrane of the present invention is advantageous in that it can be used in long (1 to 3 meters length) tubular elements and modules.

In the case where at least one chemical reaction occurs in the reaction mixture, the membrane elements and modules described in the present invention can operate as membrane reactors. They can be used to increase at least one of the following characteristics of the chemical process: yield, selectivity, conversion.

### Application to Thin Layer Chromatography (TLC) and Column Chromatography

In another aspect of the invention relating to TLC and column chromatography, the method of coating the substrate is reactive PVD, preferably in a continuous roll to roll process. TLC plates are constructed from a support layer and an alumina adsorbent layer. The support layer (substrate) is generally aluminum foil 30-150 microns thick or alternatively may be any suitable plastic film. The adsorbent layer is typically 100-350 microns thick and it is thermally evaporated by reactive PVD to obtain a highly porous, powder-like alumina coating with porosity ranging from 60% up to 95%. (For some applications, however, the layer may have a thickness of about 5-50 microns.) This highly porous alumina layer requires no adhesives or bonding compounds to maintain mechanical stability and therefore, in principle is completely free from possible contaminants. Additional sub-layers and top layers can be applied in order to better highlight fluid flow or to protect the adsorbent coating. The alumina coating is produced inside a vacuum roll coater, where aluminum web is transported over an aluminum thermal evaporator. The evaporated aluminum interacts and oxidizes in a controlled environment containing an oxygen/argon gas mixture prepared inside the vacuum chamber. The substrate is pre-treated by a plasma process to remove all contaminants and to provide reliable coating adhesion to the substrate surface.

Further, an oxide tie-layer is desirably sputtered on the substrate prior to the adsorbent layer to promote interlayer bonding. The temperature of the substrate reaches 400° C. during the coating process, and the pressure in the deposition cloud is maintained at 7×10⁻³ mbar.

As regards the aspect of the invention in which a membrane is adapted as a plate for thin layer chromatographic (TLC) identification and (or) separation of components of fluid mixtures, the TLC plates are constructed from a non-porous substrate or support layer and an alumina adsorbent layer. The support layer (substrate) is preferably aluminum foil 30-150 microns thick or alternatively can be any suitable polymeric film or sheet.

By way of example of polymeric substrates, polyester sheets (about 0.2 mm thick) can be economically coated, since they can be manufactured in roll form. Other advantages are that polyester sheets are practically unbreakable, and they need less packing and less shelf space for storage. Furthermore, they can be cut and eluted, etc. Small sheets, such as 8×4 cm, can be economically manufactured and packed. The charring technique can be applied for silica coated sheets, however, at somewhat lower temperatures than on glass. The typical maximum temperature for such sheets is 160° C. Similar sheets are also available with aluminum oxide, cellulose, and polyamide layers.

The adsorbent layer is 100-350 microns thick and is thermally evaporated by reactive PVD to obtain a highly porous, powder-like alumina coating with porosity ranging from 60% to 95%! This highly porous alumina layer requires no adhesives or bonding compounds to maintain mechanical stability and therefore is completely free from such contaminants. Additional sub layers and top layers can be applied in order to better highlight fluid flow or protect the adsorbent coating.

As regards the aspect of the invention in which a membrane is adapted for column chromatography, the column is constructed from an outer tube casing into which a rolled coated foil is inserted. The rolled coated foil resembles that of the TLC application; however, the substrate would preferably be as thin and soft as possible. The coating is of the same nature—highly porous reactively deposited alumina, and can be of greater thicknesses then in the case of the TLC application. The column can be used as a separator device with outlets at different heights in the column casing.

Advantages of the Present PVD-Deposited Coatings for TLC and Column Chromatography

### 1. High porosity.

### 2 Mechanical stability (e.g. bending strength) despite absence of a binder.

### 3. Range of working temperatures, up to 450° C., may be attained.

### 4. May be readily cut to desired size, e.g., with scissors.

### 5. Additional sub- and top-layers may be produced simultaneously, e.g. to better highlight fluid flow or for protection of the adsorbent layer.

### 6. Exceptional chemical purity of coating due to extremely high purity of reactive deposition materials, besides absence of binder.

### 7. UV fluorescence of the coating may be created e.g., by addition of rare earth ions, such as by simultaneous deposition.

### 8. A black background may be readily produced to improve optic contrast of images in the case of fluorescent visualization.

### 9. The present PVD method is ecologically clean and user-friendly.

### 10. The present PVD method can be operated continuously at relatively low cost.

11. These chromatographic tools may be applied e.g., for analysis and separation of a wide variety of materials, such as organic and inorganic chemical compositions, biochemical compositions, drugs, drug metabolites, cells, cell material, micro-organisms, peptides, polypeptides, proteins, lipids, carbohydrates, nucleic acids, and combinations thereof.

The invention is illustrated by the following non-limiting examples.

### EXAMPLE 1

### Deposition of a Ceramic (Alumina) Layer onto a Stainless Steel Mesh Substrate in a Vacuum Evaporation Apparatus Operating in Batch Mode

The substrate is a stainless steel mesh from KOIWA KANAAMI CO. having the following parameters: thickness of 38±2 μm, aperture size 46 μm, strand width 18 μm; and open area 51% was annealed for one hour at a temperature of 450-500° C. to remove residual oil and was placed in a deposition chamber from which air was then evacuated until a vacuum of 2·10⁻⁴ Torr was attained. An aluminum wire intended for evaporation was wound onto a drum and fed to the evaporation boat at a rate of 0.64-0.68 g/min, where it was evaporated by thermal resistive evaporation onto one side of the stainless steel mesh at a temperature of about 250-270° C., while oxygen in an amount varied between 320 cc/min and 340 cc/min, and argon in an amount varied between 45 cc/min and 50 cc/min (volume flow rates of both gases are referred to standard conditions) were introduced into the chamber. Partial pressures of oxygen varied within 6.0·10⁻⁴-8.0·10⁻⁴ Torr and argon within 4.0·10⁻³-4.5·10⁻³ Torr. Other gases (such as hydrogen, nitrogen, carbon dioxide and water vapor) in an amount significantly less than the amounts of oxygen and argon were also present in the chamber. The deposit which is a porous alumina layer having a thickness of 15 μm was applied onto the substrate at a rate of 600 to 750 Å/sec. The product is a composite membrane having a ceramic selective layer.

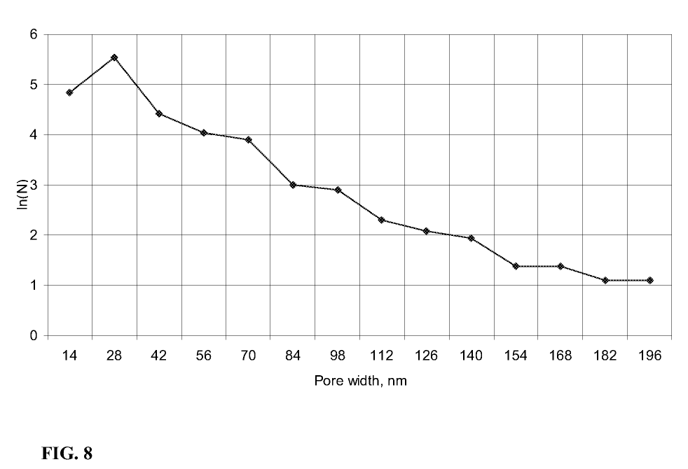

A scanning electron microscope (SEM) micrograph of the fabricated layer is shown in FIG. 3A, from which it can be seen that the fabricated layer has a dendrite structure. Further, the surface characterization was performed using a scanning electron microscope. Top-view secondary electrons (SE) images of the surface were further processed by Particle Analysis module of Digital Micrograph (GATAN Inc., USA) in order to count the number of pores of each pore width. The resulting pore distribution chart is presented in FIG. 8, in which N is the counted number of pores of the measured width. It can be seen that in the produced layer narrow pores have a width in the range of about between 14 and 42 nm, while wide pores have a width in the range of about between 154 and 196 nm.

### EXAMPLE 2

### Deposition of a Ceramic (Aluminum/Alumina) Layer onto a Stainless Steel Mesh Substrate in a Vacuum Evaporation Apparatus Operating in Batch Mode

The substrate is a stainless steel mesh from KOIWA KANAAMI CO. having the following parameters: thickness of 38±2 μm, aperture size 46 μm, strand width 18 μm; and open area 51% was annealed for one hour at a temperature of 450-500° C. to remove residual oil and was placed in a deposition chamber from which air was then evacuated until a vacuum of 2·10⁻⁴ Torr was attained. An aluminum wire intended for evaporation was wound onto a drum and fed to the evaporation boat at a rate of 0.64-0.68 g/min, where it was evaporated by thermal resistive evaporation onto one side of the stainless steel mesh at a temperature of about 270-300° C., while oxygen in an amount varied between 90 cc/min and 100 cc/min, and argon in an amount varied between 45 cc/min and 50 cc/min (volume flow rates of both gases are referred to standard conditions) were introduced into the chamber. Partial pressures of oxygen varied within 4.5·10⁻⁵-5.5·10⁻⁵ Torr and argon within (4.5-5.5)·10⁻³ Torr. Other gases (such as hydrogen, nitrogen, carbon dioxide and water vapor) in an amount significantly less than the amounts of oxygen and argon were also present in the chamber. The deposit, which is a porous layer having a thickness of 20 μm, composed of aluminum and aluminum oxide, was applied onto the substrate at a rate of 500 to 600 Å/sec. The product is a composite membrane having a ceramic selective layer.

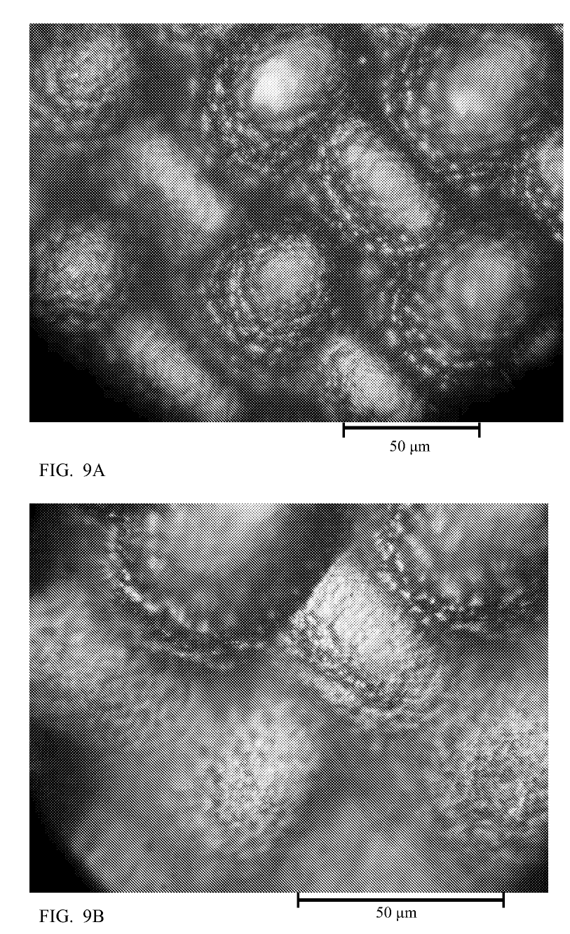

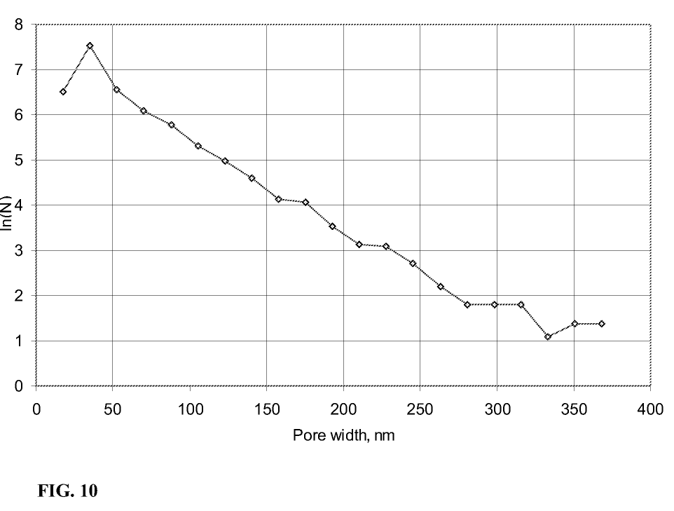

Top view images, obtained by an optical microscope, of the composite membrane are shown in FIG. 9A (magnification 700) and FIG. 9B (magnification 1100), from which it can be seen that the deposited layer has a cauliflower-like structure and repeats the relief of the surface of the substrate. Further, the surface characterization was performed using the same method and instruments as in Example 1. The resulting pore distribution chart is presented in FIG. 10, from which it can be seen that the fabricated coating has narrow pores in the width range of about between 20 and 50 nm, and wide pores in the width range of about between 330 and 370 nm.

### EXAMPLE 3

### Deposition of a Ceramic (Alumina) Layer onto Through Hole-Type Etched Aluminum Foil in a Vacuum Evaporation Apparatus Operating in Batch Mode

This was carried out similarly to Example 1, with the difference that the substrate was through hole-type etched aluminum foil and the deposited layer had a thickness of 12 μm. The product is a composite membrane having a ceramic selective layer.

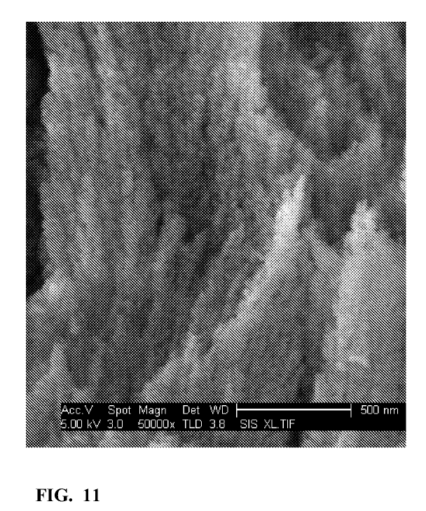

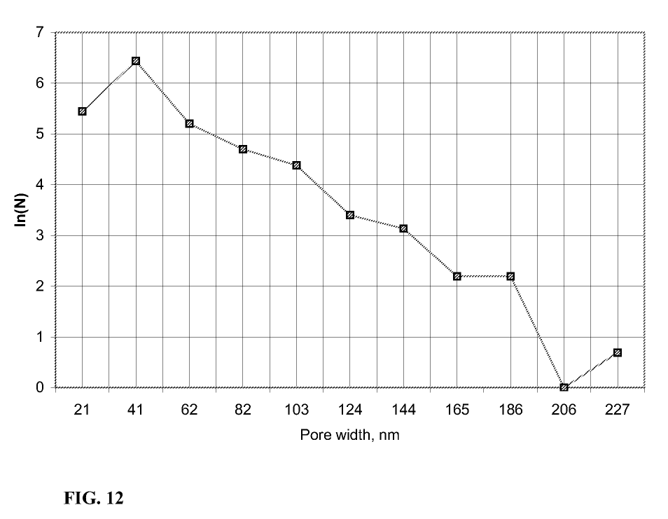

A SEM micrograph of the deposited layer is shown in FIG. 11, from which it can be seen that the deposited layer has a dendrite structure. Further, the surface characterization was performed using the same method and instruments as in Example 1. The resulting pore distribution chart is presented in FIG. 12, from which it can be seen that the deposited layer has narrow pores in the width range of about between 21 and 62 nm, and wide pores of width about 227 nm.

### EXAMPLE 4

### Deposition of a Ceramic (Aluminum/Alumina) Layer onto Through Hole-Type Etched Aluminum Foil in a Vacuum Evaporation Apparatus Operating in Batch Mode

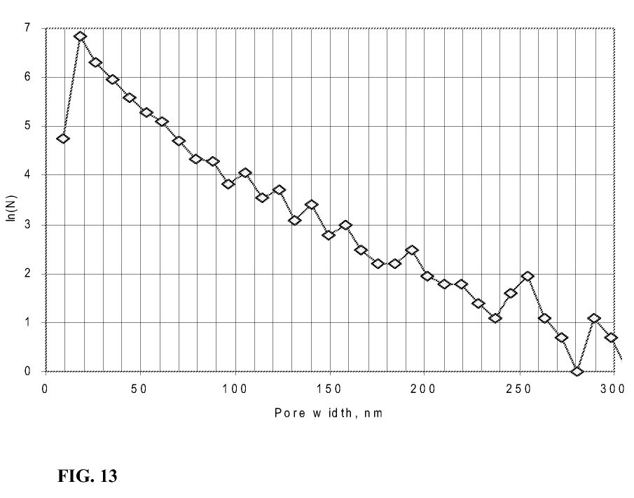

This was carried out similarly to Example 2, with the difference that the substrate was the through hole-type etched aluminum foil and the deposited layer had a thickness of 18 μm. The resultant product was a composite membrane having a ceramic selective layer. The SEM micrograph of the deposited layer is shown in FIG. 2C, from which it can be seen that the deposited layer has a cauliflower-like structure. Further, the surface characterization was performed using the same method and instruments as in Example 1. The resulting pore distribution chart is presented in FIG. 13, from which it can be seen that the deposited layer has narrow pores in the width range of about between 10 and 35 nm, and wide pores in the width range of about between 290 and 300 nm.

### EXAMPLE 5

### Sequential Double-Sided Deposition of Ceramic and Metallic Layers in a Combined Apparatus Operating in Continuous Mode

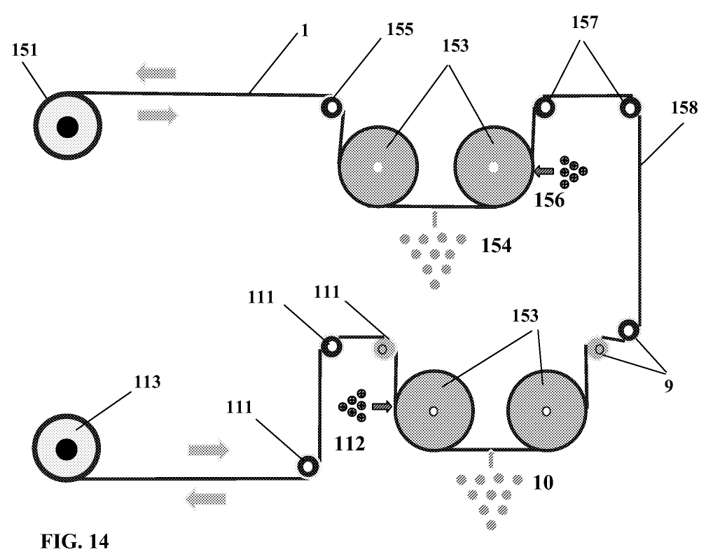

In this example, the ceramic layer and the metallic layer were sequentially deposited onto one side of the substrate in the combined evaporation-sputtering apparatus, including an evaporation zone and a sputtering zone and operating in continuous mode (FIG. 14). Substrate 1 which is a stainless steel mesh web from KOIWA KANAAMI CO. with the same characteristics as in Example 2 was unrolled in the inside of a vacuum chamber by means of a let-off roll 151, was passed on roll 155 and was allowed to travel toward evaporation zone 154 of the vacuum chamber. In the evaporation zone a mixed aluminum/alumina (ceramic) layer of 20 μm-thickness was deposited onto the substrate in a free-span mode (that is it was deposited onto that part of the substrate which is between two rolls 153) under the same deposition conditions as in Example 2.

Thereafter, the web was allowed to travel towards a sputtering zone 156, where a 0.5 μm-thick metallic layer composed of Pd and Ag was deposited onto the surface of the previously deposited ceramic layer in an atmosphere of argon with pressure of 0.5·10⁻² Torr. Sputtering was performed with a DC power supply using a power control method allowing equipment to automatically determine the sputtering voltage and current in order to maintain constant power with maximum deposition control. The layer was applied using a planar cathode with a single target which is Pd—Ag alloy.

The web 158 with the deposited ceramic and metallic layers was then passed on several rolls 157 so as to change its travel direction, and was allowed to travel toward the second evaporation zone 10, and then toward the second sputtering zone 112 where a 20 μm-thick ceramic layer (mixed aluminum/alumina) and a 0.5 μm-thick metallic layer (composed of Pd and Ag) were sequentially deposited onto the other side of the web in a manner and with deposition conditions similar to those of the first side. Finally, the substrate with deposited ceramic and metallic layers on both sides (double-sided composite membrane) passed on several rolls 111 and was allowed to travel toward roll-up roll 113 where it was rolled up.

### EXAMPLE 6

### Sequential Single-Sided Deposition of Ceramic and Metallic Layers in a Combined Apparatus Operating in Continuous Mode

This was carried out similarly to Example 5, with the difference that the deposition in zones 10 and 112 was not conducted. After deposition of the metallic layer in zone 156 web 158, which is a single-sided composite membrane, sequentially passed on rolls 157, 9 and 111 and was allowed to travel toward roll-up roll 113 where it was rolled up.

### EXAMPLE 7

### Sequential Single-Sided Deposition of a Plurality of Ceramic and Metallic Layers (Multi-Layer System) in a Combined Apparatus Operating in Continuous Mode

In this example, a plurality of ceramic layers and metallic layers were sequentially deposited in an alternating manner onto one side of the substrate in the combined evaporation-sputtering apparatus, including one evaporation zone 154 and one sputtering zone 156 and operating in continuous mode. In the process of this example, evaporation zone 10 and sputtering zone 112 did not operate.

Substrate 1 which is a stainless steel mesh web from KOIWA KANAAMI CO. with the same characteristics as in Example 2 was unrolled in the inside of a vacuum chamber by means of a let-off roll 151. Then the web passed on roll 155 and was allowed to travel toward evaporation zone 154 of the vacuum chamber, where a mixed aluminum/alumina (ceramic) layer of about 1 μm-thick was deposited onto the substrate in a free-span mode under the same deposition conditions as in Example 2. Sputtering zone 156 of the apparatus did not operate. Afterwards, the web passed on several rolls 157, 9 and 111 and was allowed to travel toward roll-up roll 113 where it was rolled up. Further direction of rotation of all the rolls was reversed, thereby reversing the traveling direction of the web. As a result, the web started unrolling on roll 113 and it was allowed to travel toward sputtering zone 156, where a metallic layer of about 0.1 μm-thickness composed of Pd and Ag was deposited onto the surface of the previously deposited ceramic layer under conditions similar to those of Example 5 (when the web traveled in the reversed direction, evaporation zone 154 of the apparatus did not operate).

After that, the web passed on roll 155 and was allowed to travel toward roll 151 where it was un-rolled. The resulting web was coated with one ceramic layer and one metallic layer. After that, the steps of direction reversing, deposition by evaporation (without sputtering) and deposition by sputtering (without evaporation) were repeated two times. The total thickness of the produced coating was 3.3 μm.

### EXAMPLE 8

### Single-Sided Deposition of Ceramic Layer and Selective Sorbent Layer

A ceramic layer with a thickness of 5 μm was deposited on one side of the non-porous aluminum foil in the apparatus of Example 1 and with deposition conditions the same as in Example 1. Furthermore, the produced membrane was placed in an electrophoretic deposition bath containing a slurry of ion-exchanged X-type zeolite particles with a size less than 1 μm where a layer of said zeolite having a thickness of 60 μm was deposited thereon.

The product which is a composite membrane comprising non-porous aluminum foil substrate 1, ceramic layer 2 (alumina) and selective sorbent layer 30 (X-type zeolite) is shown schematically in FIG. 4A.

### EXAMPLE 9

### Single-Sided Deposition of Ceramic Layer and Layer of Selectively Binding Material

A ceramic layer with a thickness of 5 μm was deposited on one side of a stainless steel mesh from KOIWA KANAAMI CO with the following characteristics: thickness—38±2 μm, aperture size—46 μm, strand width—18 μm, open area—51% in the apparatus of and under deposition conditions the same as in Example 1. The obtained product was a membrane having a single fractal-structured surface.

A dispersion of latex containing oxirane groups was prepared according to the technique disclosed in Example 2 of U.S. Pat. No. 5,976,527. The particles of the latex produced then were coated onto the surface of the ceramic layer of the single-fractal-structured-surface membrane by dip coating. Another side of the membrane (which does not contain a ceramic layer) was protected from the latex particles by a screen.

Similar to the system taught in U.S. Pat. No. 5,976,527 the manufactured composite membrane can be used for immobilizing enzymes or proteins.

### EXAMPLE 10

### Preparation of a TLC Plate

In a PVD roll coating apparatus, a hard-tempered non-porous aluminum web having 120 micron thickness and 300 mm width, having been pretreated by a plasma process to remove all contaminants from its surface, and on which a tie layer of dense 2-4 nm thick Al₂O₃ has been reactively sputtered to promote interlayer bonding (adhesion), is transported over an aluminum thermal evaporator. The evaporated aluminum reacts in a controlled environment containing an oxygen/argon mixture. During the travel from evaporator to substrate, the reacted aluminum particles cluster to form Al₂O₃ in a unique highly porous structure having a thickness of approximately 250 microns. The alumina clusters then accumulate on the substrate to form the required adsorbent layer for TLC chromatography. The temperature of the substrate reaches 400° C. during the coating process. The total pressure in the chamber is maintained at 0.007 mllibar (=0.00525 torr or 0.0007 kPa).

### EXAMPLE 11

### Preparation of a Chromatographic Column

The coating procedure is similar to Example 10, except that the non-porous substrate was soft tempered aluminum foil, 60 microns thick and 300 mm in width. The coated substrate, when rolled up, may be adapted for insertion into columns of various sizes, e.g., a glass column, inner diameter 16 mm, length 100 to 300 mm.

Although the invention has been described with respect to a limited number of embodiments, it is evident that many alternatives, modifications and variations will be apparent to those skilled in the art. Accordingly, the invention is intended to embrace all such alternatives, modifications and variations that fall within the spirit and scope of the appended claims.

1. A composite membrane adapted for separation of components of fluid mixtures, and which includes a porous, essentially continuous, vacuum-deposited ceramic layer, supported by a porous substrate, said ceramic layer comprising at least one metal oxide selected from the group consisting of oxides of aluminum, titanium, tantalum, niobium, zirconium, silicon, thorium, cadmium and tungsten, wherein the average width of the pores of said substrate is greater than that of the pores of said ceramic layer, and at least one of the following conditions is fulfilled, namely:
(a) said ceramic layer has a fractal surface structure;
(b) said ceramic layer consists essentially of a mixture of metal(s) and oxide(s) thereof;
(c) said membrane has sufficient flexibility enabling it to be rolled up and unrolled;
(d) there is disposed on the surface of said ceramic layer a vacuum-deposited metallic layer, wherein the porosity and (or) average pore width of said metallic layer is less than the porosity and average pore width, respectively, of said ceramic layer.

2. A membrane according to claim 1, wherein said supported ceramic layer is disposed on one side only of said substrate.

3. A membrane according to claim 1, wherein said supported ceramic layer is disposed on both sides of said substrate.

4. A membrane according to claim 1, wherein said supported ceramic layer is disposed on one side only of said substrate, and wherein there is disposed on the surface of said ceramic layer a vacuum-deposited metallic layer, wherein the porosity and (or) average pore width of said metallic layer is less than the porosity and average pore width, respectively, of said ceramic layer.

5. A membrane according to claim 1, wherein said supported ceramic layer is disposed on both sides of said substrate, thus defining two ceramic layer surfaces, and wherein there is disposed on at least one of said two surfaces, a vacuum-deposited metallic layer or layers, wherein the porosity and (or) average pore width of said metallic layer(s) is less than the porosity and (or) average pore width, respectively, of said ceramic layer.

6. A membrane according to claim 1, wherein at least one of the following further conditions is fulfilled, namely:
(i) said vacuum-deposited ceramic layer has been deposited by physical vapor deposition (PVD);
(ii) said substrate is a metallic substrate;
(iii) said ceramic layer has a fractal surface structure selected from dendrite, cauliflower-like and coral-like fractal surface structures;
(iv) said ceramic layer consists essentially of a mixture of aluminum metal and alumina;
(v) said supported ceramic layer is disposed on both sides of said substrate, both ceramic sides being also bonded to each other through the pores of the substrate, thereby imparting improved mechanical strength to the membrane.

7. A membrane according to claim 6, wherein said substrate is selected from stainless steel mesh and through-hole type etched aluminum foil.

8. A composite membrane adapted for separation of components of fluid mixtures, and which includes a multi-layer system of at least two porous, essentially continuous, vacuum-deposited ceramic layers, disposed on at least one side of, and supported by, a porous substrate, said ceramic layers comprising at least one metal oxide selected from the group consisting of aluminum, titanium, tantalum, niobium, zirconium, silicon, thorium, cadmium and tungsten oxides, wherein between any successive ceramic layers, there is disposed a vacuum-deposited metallic layer wherein the porosity and (or) average pore width of said metallic layer is less than the porosity and average pore width, respectively, of said ceramic layer, at least one of the following conditions being also optionally fulfilled, namely:
(a) at least one of said ceramic layers has a fractal surface structure;
(b) said ceramic layers consist essentially of a mixture of metal(s) and oxide(s) thereof;
(c) said membrane has sufficient flexibility enabling it to be rolled up and unrolled;
(d) there is disposed on the surface of any outermost ceramic layer a vacuum-deposited metallic layer, wherein the porosity and (or) average pore width of said metallic layer is less than the porosity and average pore width, respectively, of said outermost ceramic layer.

9. A membrane according to claim 8, wherein said multi-layer system is disposed on one side only of said substrate, and optionally, a single ceramic layer comprising at least one metal oxide selected from the group consisting of aluminum, titanium, tantalum, niobium, zirconium, silicon, thorium, cadmium and tungsten oxides, is disposed on the other side of said substrate and is supported thereby.

10. A membrane according to claim 8, wherein said multi-layer system is disposed on both sides of said substrate.

11. A membrane according to claim 8, wherein said multi-layer system is disposed on one side only of said substrate, optionally, a single ceramic layer as defined in claim 9 is disposed on the other side of said substrate and is supported thereby, and wherein there is disposed on the surface of one or both outermost ceramic layer(s) a vacuum-deposited metallic layer, wherein the porosity and (or) average pore width of said metallic layer is less than the porosity and average pore width, respectively, of said outermost ceramic layer(s).

12. A membrane according to claim 8, wherein said multi-layer system is disposed on both sides of said substrate, and there is disposed on the surface of at least one of the two outermost ceramic layers, a vacuum-deposited metallic layer or layers, wherein the porosity and (or) average pore width of said metallic layer(s) is less than the porosity and average pore width, respectively, of said outermost ceramic layer(s).

13. A membrane according to claim 8, wherein at least one of the following further conditions is fulfilled, namely:
(i) said vacuum-deposited ceramic layers are physically vacuum-deposited (PVD) ceramic layers;
(ii) said substrate is a metallic substrate;
(iii) said ceramic layers have a fractal surface structure selected from dendrite, cauliflower-like and coral-like fractal surface structures;
(iv) said ceramic layers consist essentially of a mixture of aluminum metal and alumina;
(v) supported ceramic layers are disposed on both sides of said substrate, both ceramic layers being also bonded to each other through the pores of the substrate, thereby imparting improved mechanical strength to the membrane.

14. A membrane according to claim 13, wherein said substrate is selected from stainless steel mesh and through-hole type etched aluminum foil.

15. A composite membrane according to claim 8, which is adapted for separation of components of fluid mixtures, by selective sorption at the membrane surface of at least one of said components, wherein each ceramic layer has a fractal surface structure and is coated with a sorbent selective layer including a substance which selectively sorbs at least one of said components, or selectively binds to at least one of said components.

16. A modification of the composite membrane according to claim 15, wherein in place of said porous substrate, there is substituted a porous substrate having unrestricted pore width and porosity.

17. A modification of the composite membrane according to claim 15, wherein in place of said porous substrate, there is substituted a non-porous substrate.

18. A membrane adapted as a plate for thin layer chromatographic identification and (or) separation of components of fluid mixtures, and which includes a single porous, essentially continuous, vacuum-deposited ceramic layer, disposed on at least one side of, and supported by, a non-porous substrate, said ceramic layer comprising at least one metal oxide selected from the group consisting of aluminum, titanium, tantalum, niobium, zirconium, silicon, thorium, cadmium and tungsten oxides.

19. A membrane according to claim 18, wherein at least one of the following conditions is also fulfilled, namely:
(α) said ceramic layer includes at least one rare earth metal;
(β) said ceramic layer has a fractal surface structure;
(γ) said non-porous substrate is selected from aluminum and polymeric substrates;
(δ) said membrane has sufficient flexibility enabling it to be rolled up and unrolled.

20. A membrane in roll form adapted as a filling for a chromatographic column, which includes a single porous, essentially continuous, vacuum-deposited ceramic layer, disposed on at least one side of, and supported by, a porous or non-porous substrate, said ceramic layer comprising at least one metal oxide selected from the group consisting of aluminum, titanium, tantalum, niobium, zirconium, silicon, thorium, cadmium and tungsten oxides.

21. A membrane according to claim 20, wherein at least one of the following conditions is also fulfilled, namely:
(α) said ceramic layer includes at least one rare earth metal;
(β) said ceramic layer has a fractal surface structure;
(γ) said non-porous substrate is selected from aluminum and polymeric substrates.
